(19) United States
(12) Patent Application Publication
(10) Pub. No.: US 2022/0207373 A1
(43) Pub. Date: Jun. 30, 2022

(54) COMPUTING DEVICE COMPENSATED FOR ACCURACY REDUCTION CAUSED BY PRUNING AND OPERATION METHOD THEREOF

(71) Applicant: SAMSUNG ELECTRONICS CO., LTD., SUWON-SI (KR)

(72) Inventors: JUHEE PARK, GWACHEON-SI (KR); HAN YOUNG YIM, SUWON-SI (KR); SANGHYUCK HA, YONGIN-SI (KR)

(21) Appl. No.: 17/348,841

(22) Filed: Jun. 16, 2021

(30) Foreign Application Priority Data
Dec. 29, 2020 (KR) 10-2020-0185775

(51) Int. Cl. G06N 3/08; G06N 3/063

(52) U.S. Cl. CPC G06N 3/082; G06N 3/063

(57) ABSTRACT

An operation method of a computing device includes selecting first data on which a first pruning is to be performed, down-scaling a first plurality of weights included in a first output channel associated with the first data, up-scaling a second plurality of weights used to generate second data to be multiplied by a weight having a major value from among the first plurality of weights included in the first output channel, calculating the second data based on the up-scaled second plurality of weights, and performing the first pruning.

### CROSS-REFERENCE TO RELATED APPLICATIONS

This U.S. nonprovisional patent application claims priority under 35 U.S.C. § 119 to Korean Patent Application No. 10-2020-0185775, filed on Dec. 29, 2020 in the Korean Intellectual Property Office, the disclosure of which is incorporated by reference herein in its entirety.

### BACKGROUND

### Technical Field

The present disclosure relates to pruning a convolution operation, and more particularly, to a computing device that compensates for the reduction of accuracy caused by the pruning and an operation method of the computing device.

### Background Art

The brain contains hundreds of billions of nerve cells, that is, neurons. The neuron may learn and remember information by exchanging signals with any other neurons through synapses. Nowadays, a neural network that mimics neurons of the human brain is being actively developed. The neural network performs convolution operations of data and weights. The neural network shows high accuracy in various fields such as image processing and object recognition. However, the neural network requires a large amount of computation, thereby causing a delay of a processing time and an increase of power consumption.

Pruning is used as a technique for reducing the amount of computation of the neural network. Pruning is a technique for omitting a convolution operation having a relatively low importance from among a plurality of convolution operations. However, as some convolution operations are omitted by the pruning, the accuracy of computation of the neural network is reduced.

### SUMMARY

Embodiments of the present disclosure provide a computing device capable of compensating for the reduction of accuracy caused by pruning and an operation method thereof.

According to an embodiment, an operation method of a computing device includes selecting first data on which a first pruning is to be performed, down-scaling a first plurality of weights included in a first output channel associated with the first data, up-scaling a second plurality of weights used to generate second data to be multiplied by a weight having a major value from among the down-scaled first plurality of weights included in the first output channel, calculating the second data based on the up-scaled second plurality of weights, and performing the first pruning.

According to another embodiment, an operation method of a computing device includes selecting first data on which a first pruning is to be performed, calculating, by an error profiler of the computing device, at least one expected value based on the first data and at least one weight to be convolved with the first data, applying the at least one expected value to at least one second data corresponding to a convolution result of the first data for purpose of compensation (e.g., to compensate for the loss of accuracy resulting from pruning), and performing the first pruning.

According to another embodiment, a computing device includes a channel pruner that selects first data on which a first pruning is to be performed and second data on which second pruning is to be performed, a scaling calculator that down-scales a first plurality of weights included in a first output channel associated with the first data and up-scales a second plurality of weights used to generate third data to be multiplied by a weight having a major value from among the down-scaled first plurality of weights included in the first output channel, an error compensator that calculates at least one expected value based on the second data and at least one weight to be convolved with the second data and that applies the at least one expected value to at least one fourth data corresponding to a convolution result of the second data for purpose of compensation (e.g., to compensate for the loss of accuracy resulting from pruning), and a convolution calculator configured to calculate the third data based on the up-scaled second plurality of weights.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating an electronic device according to an embodiment of the present disclosure.

FIG. 2 is a block diagram illustrating a computing device of FIG. 1 in more detail, according to some embodiments of the present disclosure.

FIG. 3A, FIGS. 3B and 3C are diagrams for describing a convolution operation according to some embodiments of the present disclosure.

FIG. 4 is a diagram for describing structured pruning according to some embodiments of the present disclosure.

FIG. 5A and FIG. 5B are diagrams for describing a scheme to compensate for the reduction of accuracy due to pruning by using scaling, according to some embodiments of the present disclosure.

FIG. 6A and FIG. 6B are diagrams for describing a scheme to compensate for the reduction of accuracy due to pruning by using an expected value, according to some embodiments of the present disclosure.

FIG. 7 is a diagram for describing a scheme to compensate for the reduction of accuracy due to pruning, according to some embodiments of the present disclosure.

FIG. 8 is a diagram for describing a scheme to compensate for the reduction of accuracy due to pruning, according to some embodiments of the present disclosure.

FIG. 9 is a flowchart illustrating an operation method of a computing device, according to some embodiments of the present disclosure.

FIG. 10 is a flowchart illustrating the operation method of FIG. 9 in more detail, according to some embodiments of the present disclosure.

FIG. 11 is a flowchart illustrating an operation method of a computing device, according to an embodiment of the present disclosure.

FIG. 12 is a flowchart illustrating the operation method of FIG. 11 in more detail, according to some embodiments of the present disclosure.

FIG. 13 is a block diagram illustrating an electronic system including a computing device, according to some embodiments of the present disclosure.

### DETAILED DESCRIPTION

Below, embodiments of the present disclosure will be described in detail and clearly to such an extent that one skilled in the art easily implements the teachings of the present disclosure.

It will be understood that, although the terms first, second, third etc. may be used herein to describe various steps, weights, data, channels, elements, or components, these steps, weights, data, channels, elements, or components should not be limited by these terms. These terms are only used to distinguish one or more steps, weights, data, channels, elements, or components from another one or more steps, weights, data, channels, elements, or components. Thus, for example, data discussed below such as sixth data could be termed third data, and an output channel discussed below such as a second output channel discussed below could be termed a fourth output channel, without departing from the teachings of the inventive concept(s) described herein.

Components described in the detailed description with reference to terms “part”, “unit”, “module”, “layer”, etc. and function blocks illustrated in drawings may be implemented in the form of software, hardware, or a combination thereof. For example, the software may be a machine code, firmware, an embedded code, and application software. For example, the hardware may include an electrical circuit, an electronic circuit, a processor, a computer, an integrated circuit, integrated circuit cores, a pressure sensor, an inertial sensor, a micro-electro-mechanical system (MEMS), a passive element, or a combination thereof.

In addition, unless differently defined, all terms used herein, which include technical terminologies or scientific terminologies, have the same meaning as that understood by one skilled in the art to which the present disclosure belongs. Terms defined in a generally used dictionary are to be interpreted to have meanings equal to the contextual meanings in a relevant technical field, and are not interpreted to have ideal or excessively formal meanings unless clearly defined in the specification.

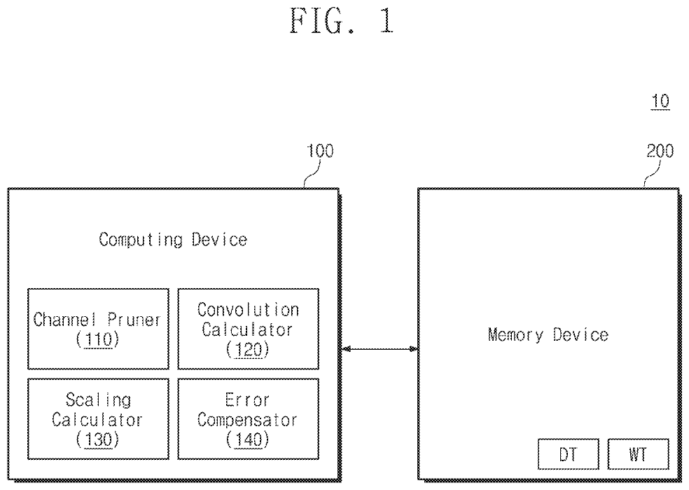

FIG. 1 is a block diagram illustrating an electronic device according to an embodiment of the present disclosure. Referring to FIG. 1, an electronic device 10 may include a computing device 100 and a memory device 200. The electronic device 10 may be an electronic device such as a mobile phone, a smart phone, a tablet personal computer (PC), a personal computer, and a laptop.

The computing device 100 may include a channel pruner 110, a convolution calculator 120, a scaling calculator 130, and an error compensator 140. The computing device 100 may communicate with the memory device 200. For example, the computing device 100 may receive at least one data DT and at least one weight WT from the memory device 200 and may output a computation result to the memory device 200.

Before proceeding, it should be clear that Figures herein, including FIG. 1, show and reference circuitry with labels such as “channel pruner”, “convolution calculator”, “scaling calculator”, “error compensator”, or similar terms analogous to “unit”, “circuit” or “block”. As is traditional in the field of the inventive concept(s) described herein, examples may be described and illustrated in terms of such labelled elements which carry out a described function or functions. These labelled elements, or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting such labelled elements may be implemented by dedicated hardware, or by a processor (e.g., one or more programmed microprocessors and associated circuitry), or by a combination of dedicated hardware to perform some functions of the labelled element and a processor to perform other functions of the labelled element. Each labelled element of the examples may be physically separated into two or more interacting and discrete circuits without departing from the scope of the present disclosure. Likewise, the labelled elements of the examples such as in the computing device 100 of FIG. 1 may be physically combined into more complex circuits without departing from the scope of the present disclosure.

For example, the data DT may be user data, such as an image, a video, an audio, a voice, or a text, or data obtained by convolving user data. For example, the weight WT may be a value that is used to determine a characteristic associated with the data DT. The weight WT may be referred to as a “kernel” or a “filter”.

The computing device 100 may be or include a processing device such as a central processing unit (CPU), a graphic processing unit (GPU), a neural processing unit (NPU), or a digital processing unit (DPU). For example, the computing device 100 may implement a convolution neural network (CNN) that performs a convolution operation. The convolution operation may be an operation for obtaining data of a next layer associated with a characteristic of the data DT based on multiplication and summation of the data DT and the weight WT.

The channel pruner 110 may select or determine data targeted for pruning from among a plurality of data. The pruning may refer to an operation for omitting a convolution operation having a relatively low importance from among a plurality of convolution operations. For example, when an expected value of the data DT is smaller than a given critical value, the channel pruner 110 may select the corresponding data DT as data to be pruned.

The channel pruner 110 may perform pruning. In some embodiments, the channel pruner 110 may perform pruning after compensating for the reduction of accuracy caused by the pruning. As some operations of convolution are omitted by the pruning of the channel pruner 110, an operating speed of the computing device 100 may be improved.

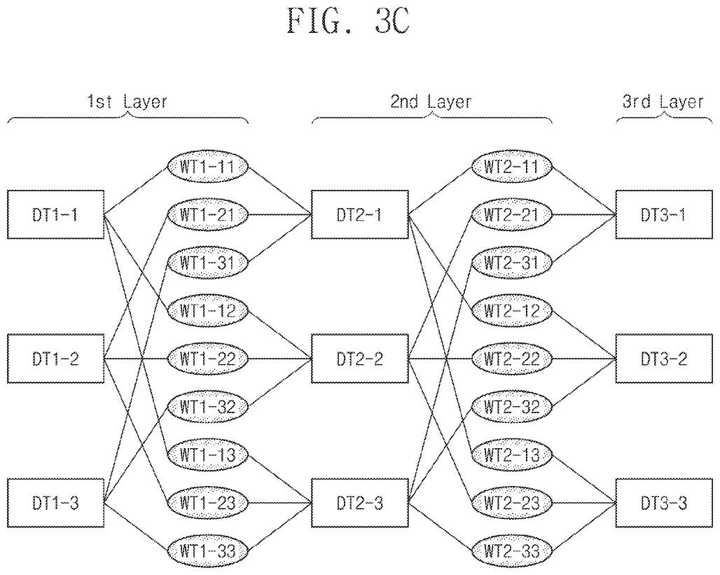

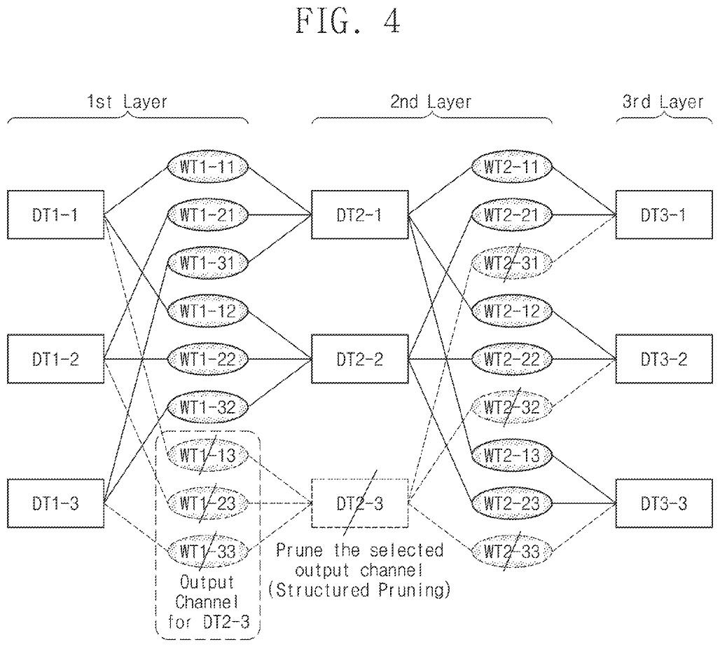

In some embodiments, the channel pruner 110 may perform structured pruning. The structured pruning may mean removing all weights included in an output channel for data to be pruned. Because computation of data to be pruned is completely omitted by the structured pruning, an operating speed by the pruning may be further improved. This will be described in more detail with reference to FIG. 4.

The convolution calculator 120 may perform a convolution operation. For example, the convolution calculator 120 may perform the convolution operation based on at least one data DT and at least one weight WT from the memory device 200. In some embodiments, the convolution calculator 120 may perform convolution on the data DT, in which compensation for the reduction of accuracy caused by the pruning is made, and the weight WT.

The scaling calculator 130 may scale a weight associated with data to be pruned. For example, the scaling calculator 130 may be configured to up-scale the weight associated with data to be pruned and/or may be configured to down-scale the weight associated with data to be pruned. Down-scaling may be for decreasing weights with scaling values (e.g., for dividing the weights by the scaling values) to down-scaled weights. Up-scaling may be for increasing the weight with the scaling value (e.g., for multiplying the weight and the scaling value together). In some embodiments, the scaling value may be a value determined in advance regardless of training.

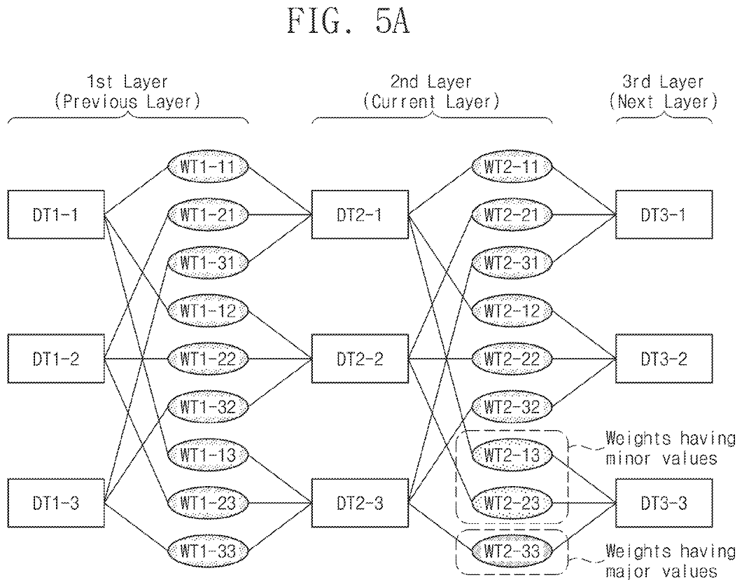

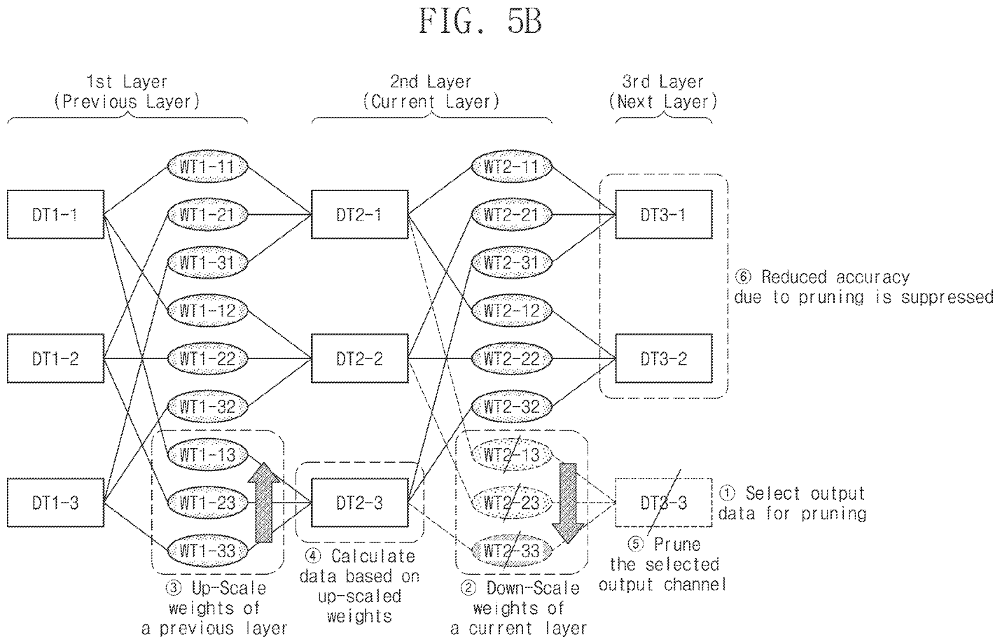

As the scaling calculator 130 scales a weight associated with data to be pruned, the reduction of accuracy caused by the pruning may be minimized. An operation of the scaling calculator 130 will be described in more detail with reference to FIG. 5A and FIG. 5B.

The error compensator 140 may compensate for an error due to the pruning. Compared with conventional pruning-free convolution, the error due to the pruning may mean that a computation result changes as some operations are omitted due to the pruning. The error compensator 140 may calculate an expected value based on data to be pruned and a weight to be convolved with the data to be pruned and may apply (or add) the expected value thus calculated to data of a next layer for the purpose of compensation (e.g., to compensate for the loss of accuracy resulting from pruning).

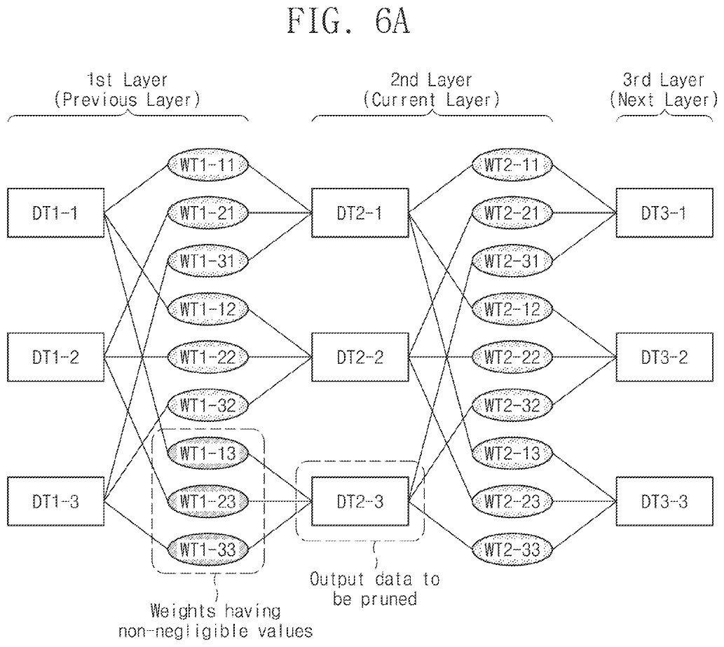

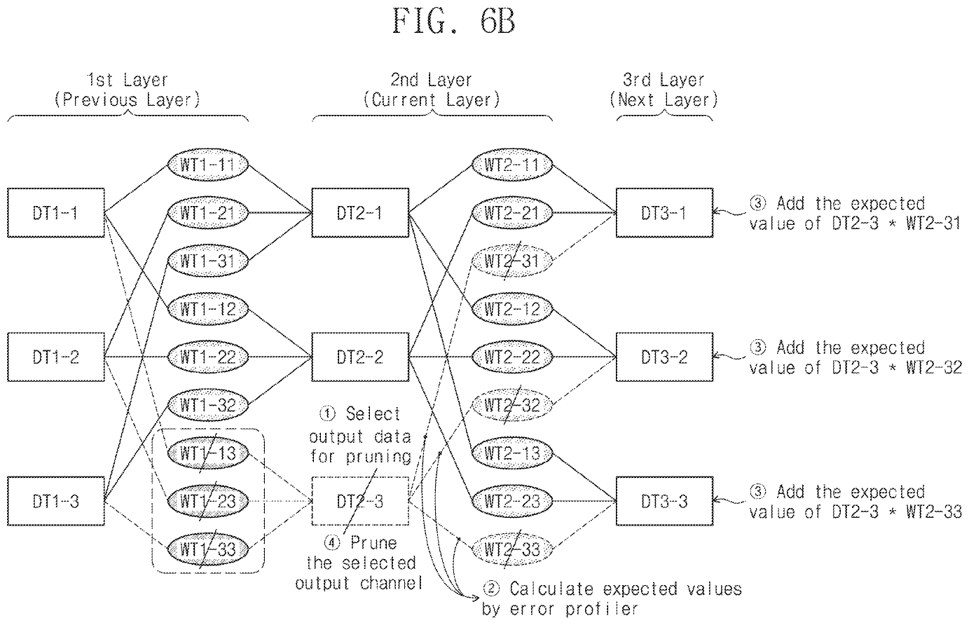

As the error compensator 140 applies the expected value to the next layer for the purpose of compensation, compensation for an error due to pruning may be made. In some embodiments, pruning associated with the error compensator 140 may be different from pruning associated with the scaling calculator 130. For example, an operation of the error compensator 140 may be independent of an operation of the scaling calculator 130, but the present disclosure is not limited thereto. An operation of the error compensator 140 will be described in more detail with reference to FIG. 6A and FIG. 6B.

The memory device 200 may store at least one data DT and at least one weight WT. For example, the memory device 200 may include a volatile memory such as a static random access memory (SRAM) or a dynamic RAM (DRAM), or a non-volatile memory such as a flash memory, a phase change RAM (PRAM), a resistive RAM (RRAM), or a magnetic RAM (MRAM).

The memory device 200 may communicate with the computing device 100. For example, the memory device 200 may output at least one data DT and at least one weight WT to the computing device 100. The memory device 200 may receive a computation result (e.g., a computation result of the convolution calculator 120) from the computing device 100.

As described above, according to an embodiment of the present disclosure, the computing device 100 with an improved operating speed may be provided by performing pruning such that some of a plurality of convolution operations are omitted. Also, the computing device 100 may compensate for the reduction of accuracy due to pruning by scaling a weight associated with data to be pruned through down-scaling and up-scaling and applying (or adding) an expected value of the data to be pruned to a next layer for the purpose of compensation (e.g., to compensate for the loss of accuracy resulting from pruning).

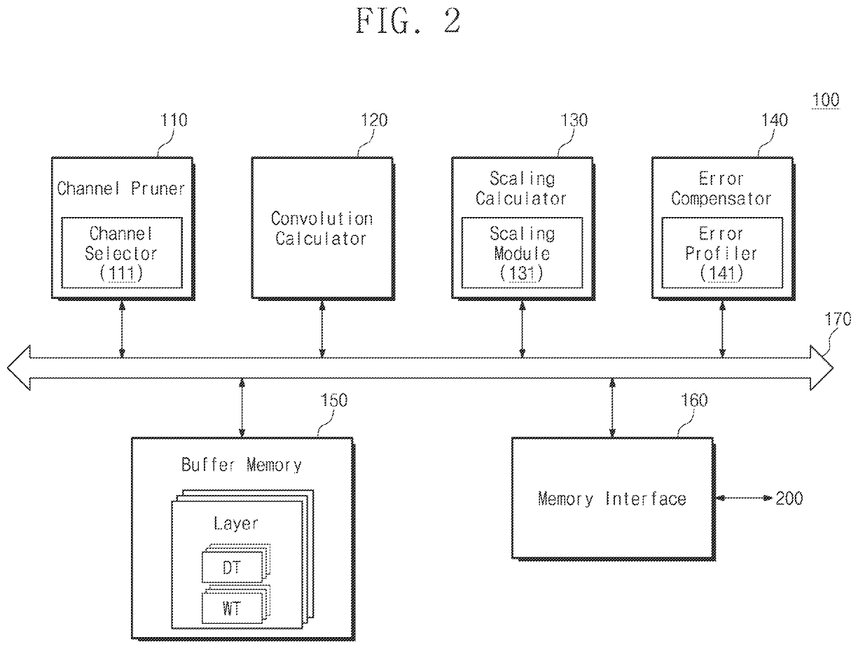

FIG. 2 is a block diagram illustrating a computing device of FIG. 1 in more detail, according to some embodiments of the present disclosure. The computing device 100 is illustrated in FIG. 2. The computing device 100 may include the channel pruner 110, the convolution calculator 120, the scaling calculator 130, the error compensator 140, a buffer memory 150, a memory interface 160, and a bus 170. The computing device 100 may communicate with the memory device 200 through the memory interface 160. In other words, the memory interface 160 is configured to communicate with an external device such as the memory device 200. The memory interface 160 may also communicate with the buffer memory 150. The bus 170 may interconnect the channel pruner 110, the convolution calculator 120, the scaling calculator 130, the error compensator 140, the buffer memory 150, and the memory interface 160.

The channel pruner 110 may include a channel selector 111. The channel selector 111 may select an output channel corresponding to data to be pruned. The output channel may include weights that are used to generate corresponding data. In some embodiments, when an expected value of data is smaller than a critical value determined in advance, the channel selector 111 may select an output channel corresponding to the corresponding data. The channel pruner 110 may remove all the weights included in the output channel selected by the channel selector 111.

The convolution calculator 120 may perform a convolution operation. In some embodiments, the convolution calculator 120 may perform a convolution operation based on a weight scaled by the scaling calculator 130. In some embodiments, the convolution calculator 120 may perform a convolution operation such that compensation for an expected value calculated by the error compensator 140 is provided.

The scaling calculator 130 may include a scaling module 131. The scaling module 131 may determine a scaling value appropriate for the output channel selected by the channel selector 111. In some embodiments, the scaling module 131 may determine a magnitude of a scaling value based on an expected value of data to be pruned. For example, the scaling value may be a positive number greater than “1”. The scaling calculator 130 may down-scale some weights associated with data to be pruned with the scaling value determine by the scaling module 131 and may up-scale the remaining weights associated with the data to be pruned.

The error compensator 140 may include an error profiler 141. The error profiler 141 may calculate an expected value of an error due to pruning through profiling. For example, in a design phase, the error profiler 141 may perform convolution of profiling data and a profiling weight to calculate data of a next layer (e.g., a result of a convolution operation) as an expected value.

The profiling data and the profiling weight in the design phase may exactly coincide with data and a weight in an actual use phase or may at least be similar to the data and the weight in the actual use phase with high probability according to a normal distribution curve. That is, an expected value by profiling may be similar to a result value of an actual convolution operation with high probability. The error compensator 140 may apply (or add) the expected value calculated by the error profiler 141 to data of a next layer for the purpose of compensation (e.g., to compensate for the loss of accuracy resulting from pruning).

The buffer memory 150 may include a plurality of layers. For example, the plurality of layers may include an input layer, at least one hidden layer, and an output layer. Each of the input layer and the at least one hidden layer may include at least one data DT and at least one weight WT. The output layer may include at least one data DT. A convolution operation may be performed in a direction from the input layer to the output layer.

The memory interface 160 may communicate with an external device such as the memory device 200 as well as with the buffer memory 150. The memory interface 160 may provide the buffer memory 150 with the data DT and the weight WT received from the memory device 200. The memory interface 160 may output a computation result of the computing device 100 to the memory device 200.

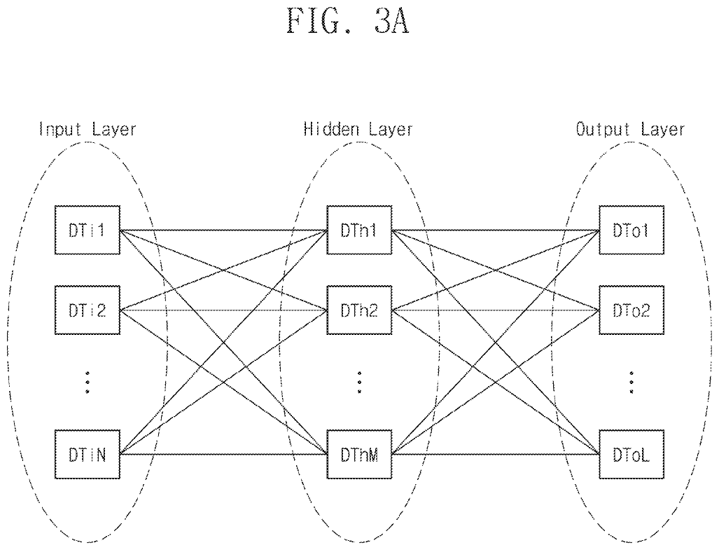

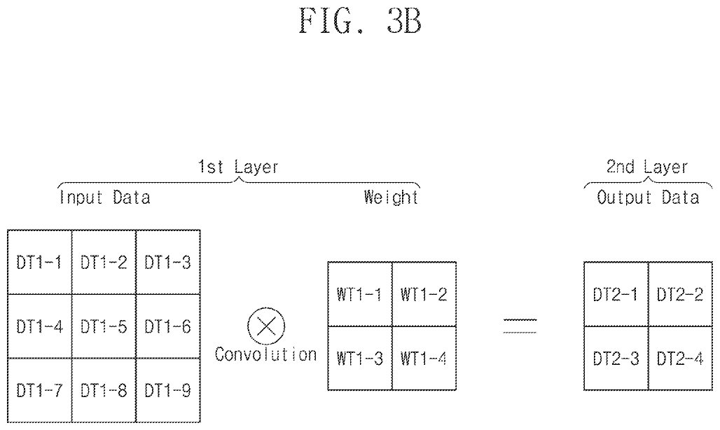

FIG. 3A, FIG. 3B and FIG. 3C are diagrams for describing a convolution operation according to some embodiments of the present disclosure. According to some embodiments, FIG. 3A is a diagram for describing some of a plurality of layers included in the buffer memory 150 of FIG. 2. Referring to FIG. 3A, an input layer, a hidden layer, and an output layer are illustrated.

A convolution operation may be performed in a direction from the input layer to the output layer. The hidden layer may be referred to as a “next layer” in relation to the input layer. For example, the hidden layer may correspond to an output of the input layer. The hidden layer may be referred to as a “previous layer” in relation to the output layer. For example, the hidden layer may correspond to an input of the output layer. For convenience of description, one hidden layer is illustrated between the input layer and the output layer, but the present disclosure is not limited thereto. For example, the number of hidden layers may increase.

The input layer may include “N” data DTi1 to DTiN. The hidden layer may include “M” data DTh1 to DThM. The output layer may include “L” data DTo1 to DToL. In this case, “N”, “M”, and “L” may be any natural number. In some embodiments, “M” may be less than “N”, and “L” may be less than “M”. That is, as a convolution operation is performed in units of layer, the amount of data and/or the number of data may decrease.

FIG. 3B is a diagram illustrating a convolution operation according to some embodiments of the present disclosure in more detail. A convolution operation may mean the process of multiplying at least one data and at least one weight and summing results, in a neural network.

Referring to FIG. 3B, a first layer and a second layer are illustrated. A convolution operation may be performed in a direction from the first layer to the second layer. For example, the first layer may correspond to an input of the convolution operation, and the second layer may correspond to an output of the convolution operation. In some embodiments, the first layer and the second layer may be the input layer and the hidden layer, respectively. Alternatively, the first layer and the second layer may be the hidden layer and the output layer, respectively.

In some embodiments, the first layer may include a plurality of input data DT1-1 to DT1-9 and a first plurality of weights WT1-1 to WT1-4. The second layer may include a plurality of output data DT2-1 to DT2-4. The plurality of output data DT2-1 to DT2-4 may correspond to results of performing a convolution operation on the plurality of input data DT1-1 to DT1-9 and the first plurality of weights WT1-1 to WT1-4.

For example, a value of the output data DT2-1 may be “DT1-1*WT1-1+DT1-2*WT1-2+DT1-4*WT1-3+DT1-5*WT1-4”. For example, a value of the output data DT2-2 may be “DT1-2*WT1-1+DT1-3*WT1-2+DT1-5*WT1-3+DT1-6*WT1-4”. For example, a value of the output data DT2-3 may be “DT1-4*WT1-1+DT1-5*WT1-2+DT1-7*WT1-3+DT1-8*WT1-4”. For example, a value of the output data DT2-4 may be “DT1-5*WT1-1+DT1-6*WT1-2+DT1-8*WT1-3+DT1-9*WT1-4”.

However, the present disclosure is not limited thereto. For example, the number of input data, the number of weights, and the number of output data may increase or decrease, and the number of input data corresponding to one convolution operation and the number of weights corresponding to one convolution operation may increase or decrease.

FIG. 3C is a diagram for describing a plurality of layers in which a convolution operation is performed, according to some embodiments. Referring to FIG. 3C, a first layer, a second layer, and a third layer are illustrated. A convolution operation may be performed in a direction from the first layer to the third layer. For example, when the second layer is referred to as a “current layer”, the first layer may be referred to as a “previous layer”, and the third layer may be referred to as a “next layer”. To help understanding of the present disclosure, fully-connected layers, that is, a first layer, a second layer and a third layer are illustrated, but the present disclosure is not limited thereto. For example, unlike the example illustrated in FIG. 3C, in some embodiments, a convolution operation may be omitted with regard to some weights.

The first layer may include a plurality of data DT1-1, DT1-2, and DT1-3, and a first plurality of weights WT1-11, WT1-21, WT1-31, WT1-12, WT1-22, WT1-32, WT1-13, WT1-23, and WT1-33. The second layer may include a plurality of data DT2-1, DT2-2, and DT2-3, and a second plurality of weights WT2-11, WT2-21, WT2-31, WT2-12, WT2-22, WT2-32, WT2-13, WT2-23, and WT2-33. The third layer may include a plurality of data DT3-1, DT3-2, and DT3-3. However, the present disclosure is not limited thereto. For example, the number of data included in each of the first layer, the second layer and the third layers may increase or decrease, and the number of weights included in each of the first layer and the second layer may increase or decrease.

In some embodiments, the second layer may correspond to a result of a convolution operation performed in the first layer. For example, a value of the data DT2-1 may be “DT1-1*WT1-11+DT1-2*WT1-21+DT1-3*WT1-31”. A value of the data DT2-2 may be “DT1-1*WT1-12+DT1-2*WT1-22+DT1-3*WT1-32”. A value of the data DT2-3 may be “DT1-1*WT1-13+DT1-2*WT1-23+DT1-3*WT1-33”.

In some embodiments, the third layer may correspond to a result of a convolution operation performed in the second layer. For example, a value of the data DT3-1 may be “DT2-1*WT2-11+DT2-2*WT2-21+DT2-3*WT2-31”. A value of the data DT3-2 may be “DT2-1*WT2-12+DT2-2*WT2-22+DT2-3*WT2-32”. A value of the data DT3-3 may be “DT2-1*WT2-13+DT2-2*WT2-23+DT2-3*WT2-33”.

In some embodiments, a computing device may calculate data of a next layer further in consideration of a bias value, as well as multiplication and summation of data and a weight. For example, the computing device may perform a convolution operation based on Equation 1 below.

$${y}_{oc = 1} = {\sum }_{ic , k ∈ IC , K} {\{ {w}_{ic , k} {x}_{c , k} \}}_{oc = 1} + {bias}_{oc = 1} \\ {y}_{oc = 2} = {\sum }_{ic , k ∈ IC , K} {\{ {w}_{ic , k} {x}_{c , k} \}}_{oc = 2} + {bias}_{oc = 2} \\ {y}_{oc = 3} = {\sum }_{ic , k ∈ IC , K} {\{ {w}_{ic , k} {x}_{c , k} \}}_{oc = 3} + {bias}_{oc = 3} \\ … \\ {y}_{oc = OC} = {\sum }_{ic , k ∈ IC , K} {\{ {w}_{ic , k} {x}_{c , k} \}}_{oc = OC} + {bias}_{oc = OC} \qquad [ Equation 1 ]$$

Equation 1 above is an equation indicating a convolution operation to which pruning is not applied in a specific layer. “x” is input data. “w” is a weight. “y” is output data. “bias” is a bias value. A bias value may mean a constant value that is independent of input data and a weight and is added for processing of output data. “oc” is a depth of an output channel. “OC” is a maximum depth of the output channel (or the number of output channels). “ic” is a depth of an input channel. “IC” is a maximum depth of the input channel (or the number of input channels). “K” is a magnitude of a weight (or the number of weights for output data).

For example, in the case of applying Equation 1 to the first layer of FIG. 3C, the data DT1-1, DT1-2, and DT1-3 may correspond to input data “x”. The maximum depth IC of the input channel may be “3”. The data DT2-1, DT2-2, and DT2-3 may correspond to output data “y”. The maximum depth OC of the output channel may be “3”. Weights of the first layer may correspond to a weight “w”.

The convolution operation that is performed in units of layer is described above with reference to FIG. 3C. In some embodiments, the convolution operation shows high accuracy in various fields of image processing and object recognition. However, the convolution operation requires a large amount of computation, thereby causing a delay of a processing time and an increase of power consumption. A pruning technique may be required to reduce a load according to the convolution operation. The pruning may mean the process of omitting some of convolution operations. This will be described in more detail with reference to FIG. 4.

FIG. 4 is a diagram for describing structured pruning according to some embodiments of the present disclosure. The structured pruning that a computing device performs according to an embodiment of the present disclosure will be described with reference to FIG. 4.

The structured pruning may mean the process of removing all the weights included in an output channel corresponding to specific data (or all the edges directly connected with a node of data to be pruned). The output channel may indicate a set of all the weights of a previous layer used to generate specific data. The structured pruning may be distinguished from general pruning in that all, not a part, of weights included in an output channel associated with specific data are removed.

The general pruning may mean the process of removing a part of weights included in an output channel associated with specific data. For example, an output channel associated with the data DT2-3 may include the weights WT1-13, WT1-23, and WT1-33. When a computing device performs the general pruning, the weight WT1-13 may be removed, and the remaining weights WT1-23 and WT1-33 may be maintained. In this case, the multiplication of the data DT1-1 and the weight WT1-13 may be omitted, but the computation of “DT1-2*WT1-23+DT1-3*WT1-33” may be required to obtain the data DT2-3. That is, in the case where the general pruning is performed, the load according to a convolution operation may not be reduced as much as in structured pruning.

According to some embodiments of the present disclosure, a computing device may perform the structured pruning. For example, the computing device may select the data DT2-3 on which the structured pruning will be performed. The computing device may prune an output channel associated with the data DT2-3. In other words, all the weights WT1-13, WT1-23, and WT1-33 included in the output channel associated with the data DT2-3 may be removed. In this case, computation for obtaining the data DT2-3 may be completely omitted. Also, convolution operations (e.g., DT2-3*WT2-31, DT2-3*WT2-32, and DT2-3*WT2-33) for a next layer based on the data DT2-3 may be completely omitted. That is, in the case where the structured pruning is performed, compared to the case where the general pruning is performed, the load according to a convolution operation may be greatly reduced.

In some embodiments, the structured pruning that is performed in the computing device will be described with reference to Equation 2 below. Equation 2 indicates an equation in which the structured pruning is applied to the convolution operation of Equation 1 above.

$${y}_{oc = 1} = {\sum }_{ic , k ∈ IC , K} {\{ {w}_{ic , k} {x}_{c , k} \}}_{oc = 1} + {bias}_{oc = 1} \\ {y}_{oc = 2} = {\sum }_{ic , k ∈ IC , K} {\{ {w}_{ic , k} {x}_{c , k} \}}_{oc = 2} + {bias}_{oc = 2} \\ \\ … \\ {y}_{oc = OC} = {\sum }_{ic , k ∈ IC , K} {\{ {w}_{ic , k} {x}_{c , k} \}}_{oc = OC} + {bias}_{oc = OC} \qquad [ Equation 2 ]$$

Equation 2 is an equation indicating the structured pruning. Reference signs included in Equation 2 are similar to reference signs included in Equation 1, and thus, additional description will be omitted to avoid redundancy. Referring to Equation 2, as the structured pruning is performed on output data y_{oc=3}, a convolution operation associated with the output data y_{oc=3} may be completely removed, and thus, the load of the convolution operation may be greatly reduced.

For example, referring to the first layer of FIG. 4 and the output data y_{oc=3} of Equation 2, the data DT1-1, DT1-2, and DT1-3 may correspond to input data “x”. The weights WT1-13, WT1-23, and WT1-33 may correspond to the weight “w”. The data DT2-3 may correspond to the output data y_{oc=3}. The convolution operation associated with the data DT2-3 may be completely removed by the structured pruning.

As described above, according to an embodiment of the present disclosure, the computing device may perform the structured pruning. When the structured pruning is performed, the load according to a convolution operation may be greatly reduced. As such, an operating speed of a neural network may be improved, and power consumption may be reduced. Meanwhile, when the structured pruning is performed, instead of individually removing a weight, all weights associated with a specific output channel may be removed. As such, an error caused by the pruning may increase. Schemes to compensate for the reduction of accuracy caused by the pruning will be described with reference to FIG. 5A, FIG. 5B, FIG. 6A, and FIG. 6B.

FIG. 5A and FIG. 5B are diagrams for describing a scheme to compensate for the reduction of accuracy due to pruning by using scaling, according to some embodiments of the present disclosure. Referring to FIG. 5A, a computing device may select the data DT3-3 on which the pruning will be performed. An output channel associated with the data DT3-3 may include the second plurality of weights WT2-13, WT2-23, and WT2-33.

In some embodiments, each of some weights WT2-13 and WT2-23 of the second plurality of weights WT2-13, WT2-23, and WT2-33 may have a minor value. The weight WT2-33 of the second plurality of weights WT2-13, WT2-23, and WT2-33 may have a major value. In this case, the minor value may be smaller than a critical value determined in advance. The minor value may mean a value having a small influence on a result of a convolution operation. The major value may be equal to or greater than the critical value determined in advance. The major value may mean a value having a great influence on a result of a convolution operation.

In the case where the computing device performs the structured pruning on the data DT3-3, there is no problem in removing some weights WT2-13 and WT2-23, but when the weight WT2-33 is removed, an error caused by the pruning may increase. As such, a scheme to compensate for the reduction of accuracy caused by a weight having a major value may be required when the structured pruning is performed.

Referring to FIG. 5B, a scheme to scale (or adjust) a weight associated with data to be pruned through down-scaling and up-scaling is provided.

In some embodiments, a computing device may select the output data DT3-3 to be pruned. The output data DT3-3 may be included in the third layer. The computing device may down-scale the second plurality of weights WT2-13, WT2-23, and WT2-33 included in the output channel associated with the data DT3-3. The second plurality of weights WT2-13, WT2-23, and WT2-33 thus down-scaled may be included in the second layer. The second layer may be a previous layer of the third layer.

The computing device may up-scale the first plurality of weights WT1-13, WT1-23, and WT1-33 that are used to generate the data DT2-3 to be multiplied by the weight WT2-33 having a major value from among the second plurality of weights WT2-13, WT2-23, and WT2-33. The data DT2-3 may be included in the second layer. The first plurality of weights WT1-13, WT1-23, and WT1-33 thus up-scaled may be included in the first layer. The first layer may be a previous layer of the second layer.

The computing device may calculate the data DT2-3 based on the up-scaled weights WT1-13, WT1-23, and WT1-33. The computing device may perform pruning on the output data DT3-3. In this case, because the compensation for an error caused by the pruning of the output data DT3-3 is applied to the remaining data DT3-1 and DT3-2 by the data DT2-3 through the down-scaling and the up-scaling, the reduction of accuracy due to the pruning may be suppressed.

In some embodiments, the computing device may prune data of the third layer and may up-scale weights of the first layer. A convolution operation in the first layer before the up-scaling is expressed by Equation 3 below.

$${y}_{layer = 1 , oc = 1} = {\sum }_{ic , k ∈ IC , K} {\{ {w}_{ic , k} {x}_{c , k} \}}_{layer = 1 , oc = 1} + {bias}_{layer = 1 , oc = 1} \\ {y}_{layer = 1 , oc = 2} = {\sum }_{ic , k ∈ IC , K} {\{ {w}_{ic , k} {x}_{c , k} \}}_{layer = 1 , oc = 2} + {bias}_{layer = 1 , oc = 2} \\ … \\ {y}_{layer = 1 , oc = OC} = {\sum }_{ic , k ∈ IC , K} {\{ {w}_{ic , k} {x}_{c , k} \}}_{layer = 1 , oc = OC} + {bias}_{layer = 1 , oc = OC} \qquad [ Equation 3 ]$$

In the case where the structured pruning is performed in the third layer, Equation 3 above indicates a convolution operation in the first layer. “x” is input data. “w” is a weight. “y” is output data. “bias” is a bias value. “oc” is a depth of an output channel. “OC” is a maximum depth of the output channel (or the number of output channels). “ic” is a depth of an input channel. “IC” is a maximum depth of the input channel (or the number of input channels). “K” is a magnitude of a weight (or the number of weights for output data). “layer” is an index of a corresponding layer (e.g., the first layer) where a convolution operation is performed.

For example, in the case of applying Equation 3 to the first layer of FIG. 5B, the data DT1-1, DT1-2, and DT1-3 may correspond to input data “x”. The data DT2-1, DT2-2, and DT2-3 may correspond to output data “y”. Weights of the first layer may correspond to a weight “w”.

In some embodiments, the computing device may prune data of the third layer and may up-scale weights of the first layer. A convolution operation in the first layer after the up-scaling is expressed by Equation 4 below.

$${α}_{1} {y}_{layer = 1 , oc = 1} = {\sum }_{ic , k ∈ IC , K} {α}_{1} {\{ {w}_{ic , k} {x}_{c , k} \}}_{oc = 1} + {α}_{1} {bias}_{oc = 1} \\ {α}_{2} {y}_{layer = 1 , oc = 2} = {\sum }_{ic , k ∈ IC , K} {α}_{2} {\{ {w}_{ic , k} {x}_{c , k} \}}_{oc = 2} + {α}_{2} {bias}_{oc = 2} \\ … \\ {α}_{OC} {y}_{layer = 1 , oc = OC} = {\sum }_{ic , k ∈ IC , K} {α}_{OC} {\{ {w}_{ic , k} {x}_{c , k} \}}_{oc = OC} + {α}_{OC} {bias}_{oc = OC} \qquad [ Equation 4 ]$$

In the case where the structured pruning is performed in the third layer, Equation 4 above indicates a convolution operation in the first layer, to which the up-scaling is applied. For convenience of description, additional description associated with reference signs that are the same as the reference signals described with reference to Equation 3 will be omitted.

Referring to Equation 4, a weight α may be multiplied by a weight and data of the first layer in units of output channel. In some embodiments, values of the weight a to be applied to output channels may be different. In some embodiments, a value of the weight α to be applied to an output channel irrelevant to the up-scaling may be “1”.

In some embodiments, the computing device may prune data of the third layer and may down-scale weights of the second layer. A convolution operation in the second layer before the down-scaling is expressed by Equation 5 below.

$${y}_{layer = 2 , oc = 1} = {\sum }_{ic , k ∈ IC , K} {\{ {w}_{ic , k} {x}_{c , k} \}}_{layer = 2 , oc = 1} + {bias}_{layer = 2 , oc = 1} \\ {y}_{layer = 2 , oc = 2} = {\sum }_{ic , k ∈ IC , K} {\{ {w}_{ic , k} {x}_{c , k} \}}_{layer = 2 , oc = 2} + {α}_{2} {bias}_{layer = 2 , oc = 2} \\ … \\ {y}_{layer = 2 , oc = OC} = {\sum }_{ic , k ∈ IC , K} {\{ {w}_{ic , k} {x}_{c , k} \}}_{layer = 2 , oc = OC} + {bias}_{layer = 2 , oc = OC} \qquad [ Equation 5 ]$$

In the case where the structured pruning is performed in the third layer, Equation 5 above indicates a convolution operation in the second layer. “x” is input data. “w” is a weight. “y” is output data. “bias” is a bias value. “oc” is a depth of an output channel. “OC” is a maximum depth of the output channel (or the number of output channels). “ic” is a depth of an input channel. “IC” is a maximum depth of the input channel (or the number of input channels). “K” is a magnitude of a weight (or the number of weights for output data). “layer” is an index of a corresponding layer (e.g., the second layer) where a convolution operation is performed.

For example, in the case of applying Equation 5 to the second layer of FIG. 5B, the data DT2-1, DT2-2, and DT2-3 may correspond to input data “x”. The data DT3-1, DT3-2, and DT3-3 may correspond to output data “y”. Weights of the second layer may correspond to a weight “w”.

In some embodiments, the computing device may prune data of the third layer and may down-scale weights of the second layer. A convolution operation in the second layer after the down-scaling is expressed by Equation 6 below.

$${y}_{layer = 2 , oc = 1} = {\sum }_{ic , k ∈ IC , K} {\{ \frac{{w}_{ic = 3 , k} {x}_{ic , k}}{{α}_{1}} + \frac{{w}_{ic = 2 , k} {x}_{ic = 2 , k}}{{α}_{2}} + ⋯ + \frac{{w}_{ic = IC , k} {x}_{ic = IC , k}}{{α}_{IC}} \}}_{oc = 1} + {bias}_{oc = 1} \\ {y}_{layer = 2 , oc = 2} = {\sum }_{ic , k ∈ IC , K} {\{ \frac{{w}_{ic = 1 , k} {x}_{ic , k}}{{α}_{1}} + \frac{{w}_{ic = 2 , k} {x}_{ic = 2 , k}}{{α}_{2}} + ⋯ + \frac{{w}_{ic = IC , k} {x}_{ic = IC , k}}{{α}_{IC}} \}}_{oc = 2} + {bias}_{oc = 2} \\ … \\ {y}_{layer = 2 , oc = OC} = {\sum }_{ic , k ∈ IC , K} {α}_{OC} {\{ \frac{{w}_{ic = 1 , k} {x}_{ic , k}}{{α}_{1}} + \frac{{w}_{ic = 2 , k} {x}_{ic = 2 , k}}{{α}_{2}} + ⋯ + \frac{{w}_{ic = IC , k} {x}_{ic = IC , k}}{{α}_{IC}} \}}_{oc = OC} + {bias}_{oc = OC} \qquad [ Equation 6 ]$$

In the case where the structured pruning is performed in the third layer, Equation 6 above indicates a convolution operation in the second layer, to which the down-scaling is applied. For convenience of description, additional description associated with reference signs that are the same as the reference signals described with reference to Equation 5 will be omitted. Referring to Equation 6, the weight a may be multiplied by a weight and data of the second layer in units of output channel. A value of the weight α in Equation 6 may correspond to a value of the weight α in Equation 4. In some embodiments, values of the weight α to be applied to output channels may be different. In some embodiments, a value of the weight α to be applied to an output channel irrelevant to the down-scaling may be “1”.

FIG. 6A and FIG. 6B are diagrams for describing a scheme to compensate for the reduction of accuracy due to pruning by using an expected value, according to some embodiments of the present disclosure. Referring to FIG. 6A, a computing device may select the data DT2-3 on which the pruning will be performed. An output channel associated with the data DT2-3 may include the first plurality of weights WT1-13, WT1-23, and WT1-33.

In some embodiments, the first plurality of weights WT1-13, WT1-23, and WT1-33 may have non-negligible values. For example, the data DT2-3 may be selected as data to be pruned because the first plurality of weights WT1-13, WT1-23, and WT1-33 are smaller than the critical value, but the pruning of the data DT2-3 may cause an error that is non-negligible in a final convolution result. As such, a scheme to compensate a convolution operation omitted in the structured pruning may be required when the structured pruning is performed.

Referring to FIG. 6B, a scheme to apply (or add) an expected value of data to be pruned to a next layer for the purpose of compensation (e.g., to compensate for the loss of accuracy resulting from pruning) is provided.

In some embodiments, a computing device may select the output data DT2-3 to be pruned. The output data DT2-3 may be included in the second layer. The computing device may include an error profiler. The error profiler may be a module for calculating an expected value of computation to be pruned. Through the error profiler, the computing device may calculate at least one expected value (e.g., an expected value of (DT2-3*WT2-31), an expected value of (DT2-3*WT2-32), and an expected value of (DT2-3*WT2-33)) based on the data DT2-3 and at least one weight WT2-31, WT2-32, and WT2-33 to be convolved with the data DT2-3. The at least one weight WT2-31, WT2-32, or WT2-33 may be included in the second layer.

The computing device may apply (or add) the at least one expected value (e.g., the expected value of (DT2-3*WT2-31), the expected value of (DT2-3*WT2-32), and the expected value of (DT2-3*WT2-33)) to the at least one data DT3-1, DT3-2, and DT3-3 corresponding to a convolution result of the data DT2-3 to be pruned, for the purpose of compensation (e.g., to compensate for the loss of accuracy resulting from pruning). The at least one data DT3-1, DT3-2, and DT3-3 may be included in the third layer. The third layer may be a next layer of the second layer. The computing device may perform pruning on the data DT2-3.

For example, in the case where the computing device performs the structured pruning on the data DT2-3, a value omitted by the structured pruning will be described with reference to Equation 7 below.

$${y}_{oc = 3} = {\sum }_{ic , k ∈ IC , K} {\{ {w}_{ic , k} {x}_{c , k} \}}_{oc = 3} + {bias}_{oc = 3} \qquad [ Equation 7 ]$$

According to some embodiments, in the case where the structured pruning is performed on the data DT2-3 of FIG. 6B, Equation 7 indicates a value to be pruned in the second layer. “x” is input data. “w” is a weight. “y” is output data. “bias” is a bias value. “oc” is a depth of the output channel (i.e., “3”). For example, “y_{oc=3}” may correspond to the data DT2-3. “w” may correspond to the weights WT1-13, WT1-23, and WT1-33. “x” may correspond to the data DT1-1, DT1-2, and DT1-3.

In this case, even though the data DT2-3 is pruned but a value by which the data DT2-3 contributes to the data DT3-1, DT3-2, and DT3-3 of the next layer, an influence of an error due to the structured pruning on the data DT3-1, DT3-2, and DT3-3 of the next layer may decrease. The value by which the data DT2-3 contributes to the data DT3-1, DT3-2, and DT3-3 of the next layer is an expected value, projected using Equation 7.

In some embodiments, the computing device may add an expected value of a convolution operation associated with data to be pruned to a bias value of a next layer. For example, the computing device may select the data DT2-3 to be pruned. The computing device may calculate an expected value for the data DT3-1 based on the multiplication of the data DT2-3 and the weight WT2-31. In a convolution operation for generating the data DT3-1, the computing device may add the expected value of (DT2-3*WT2-31) to a bias value for the data DT3-1.

Also, in a convolution operation for generating the data DT3-2, the computing device may add the expected value of (DT2-3*WT2-32) to a bias value for the data DT3-2. In a convolution operation for generating the data DT3-3, the computing device may add the expected value of (DT2-3*WT2-33) to a bias value for the data DT3-3.

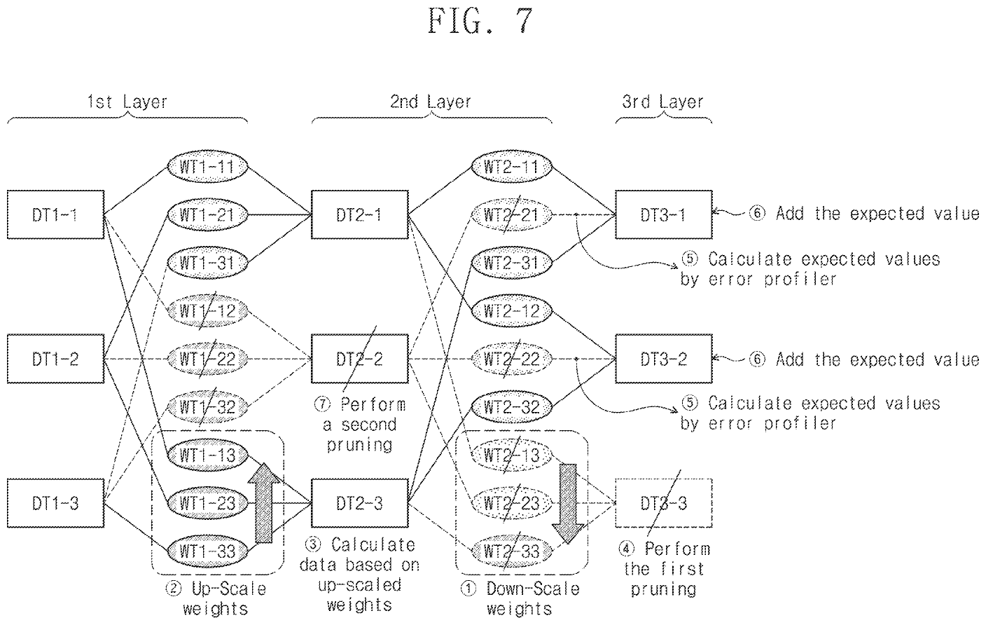

FIG. 7 is a diagram for describing a scheme to compensate for the reduction of accuracy due to pruning, according to some embodiments of the present disclosure. Referring to FIG. 7, a computing device may sequentially perform first pruning and second pruning.

The computing device may down-scale the second plurality of weights WT2-13, WT2-23, and WT2-33 included in the output channel associated with the data DT3-3 on which the first pruning will be performed. The computing device may up-scale the first plurality of weights WT1-13, WT1-23, and WT1-33 that are used to generate the data DT2-3 to be multiplied by the weight WT2-33 having a major value from among the second plurality of weights WT2-13, WT2-23, and WT2-33 of the output channel for the data DT3-3. The computing device may calculate the data DT2-3 based on the up-scaled weights WT1-13, WT1-23, and WT1-33. The computing device may perform the first pruning on the data DT3-3.

The computing device may select the data DT2-2 on which the second pruning will be performed. Through the error profiler, the computing device may calculate at least one expected value (e.g., DT2-2*WT2-21 and DT2-2*WT2-22) based on the data DT2-2 and the weights WT2-21 and WT2-22 to be convolved with the data DT2-2. In this case, because the weight WT2-23 is already removed by the first pruning, calculating an expected value based on the data DT2-2 and the weight WT2-23 may be omitted.

The computing device may add the at least one expected value (e.g., DT2-2*WT2-21 and DT2-2*WT2-22) to the at least one data (e.g., DT3-1 and DT3-2) corresponding to a convolution result of the data DT2-2. In this case, because the data DT3-3 are already removed by the first pruning, applying an expected value to the data DT3-3 for the purpose of compensation (e.g., to compensate for the loss of accuracy resulting from pruning) may be omitted. The computing device may perform the second pruning on the data DT2-2.

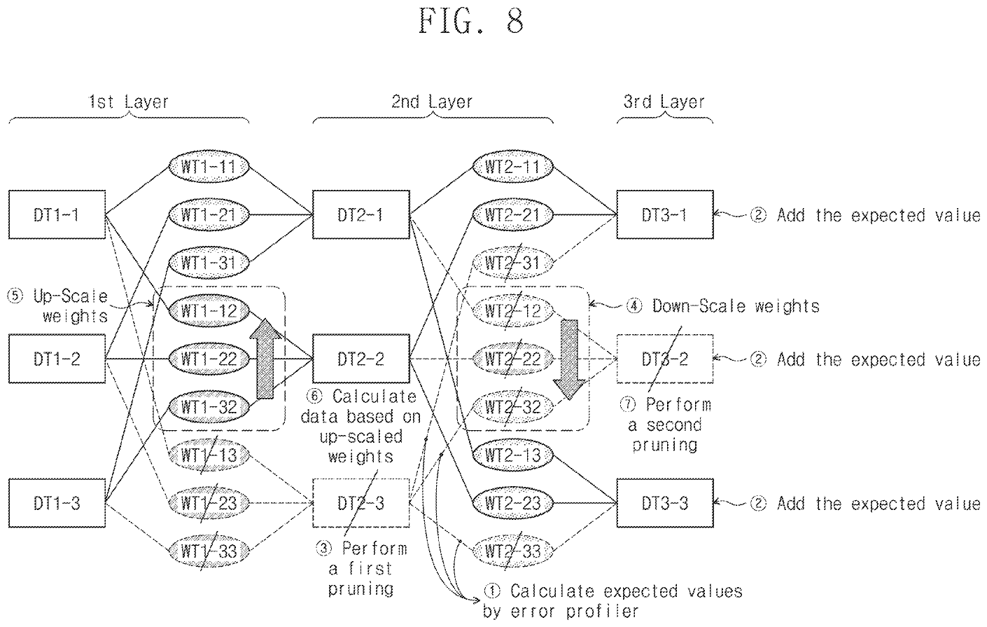

FIG. 8 is a diagram for describing a scheme to compensate for the reduction of accuracy due to pruning, according to some embodiments of the present disclosure. Referring to FIG. 8, a computing device may sequentially perform first pruning and second pruning. The first pruning and the second pruning of FIG. 8 may correspond to the second pruning and the first pruning of FIG. 7, respectively.

The computing device may select the data DT2-3 on which the first pruning will be performed. Through the error profiler, the computing device may calculate expected values (e.g., DT2-3*WT2-31, DT2-3*WT2-32, and DT2-3*WT2-33) based on the data DT2-3 and the weights WT2-31, WT2-32, and WT2-33 to be convolved with the data DT2-3.

The computing device may add the expected values (e.g., DT2-3*WT2-31, DT2-3*WT2-32, and DT2-3*WT2-33) to at least one data (e.g., DT3-1, DT3-2, and DT3-3) corresponding to a convolution result of the data DT2-3, respectively. The computing device may perform the first pruning on the data DT2-3.

The computing device may down-scale the second plurality of weights WT2-12 and WT2-22 included in the output channel associated with the data DT3-2 on which the second pruning will be performed. In this case, because the weight WT2-32 is already removed by the first pruning, down-scaling the weight WT2-32 may be omitted. The computing device may up-scale the first plurality of weights WT1-12, WT1-22, and WT1-32 that are used to generate the data DT2-2 to be multiplied by the weight WT2-22 having a major value from among the second plurality of weights WT2-12 and WT2-22 of the output channel for the data DT3-2. The computing device may calculate the data DT2-2 based on the up-scaled weights WT1-12, WT1-22, and WT1-32. The computing device may perform the second pruning on the data DT3-2.

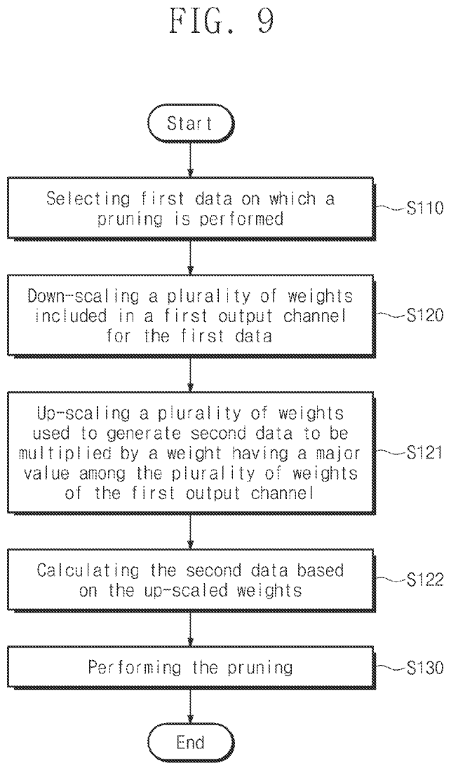

FIG. 9 is a flowchart illustrating an operation method of a computing device according to some embodiments of the present disclosure. An operation method of a computing device is illustrated in FIG. 9. The computing device may communicate with a memory device. In operation S110, the computing device may select first data on which the first pruning will be performed.

In operation S120, the computing device may down-scale a first plurality of weights included in a first output channel associated with the first data. In some embodiments, the computing device may down-scale the plurality of weights included in the first output channel to a plurality of predetermined scaling values, respectively.

In operation S121, the computing device may up-scale a second plurality of weights that are used to generate second data to be multiplied by a weight having a major value from among the first plurality of weights included in the first output channel. In some embodiments, the computing device may up-scale the plurality of weights used to generate the second data with a plurality of predetermined scaling values, respectively. In this case, the plurality of predetermined scaling values may correspond to the plurality of predetermined scaling values used for the down-sampling in operation S120.

In operation S122, the computing device may calculate the second data based on the up-scaled weights. In some embodiments, the computing device may convolve the up-scaled weights and a plurality of third data to obtain the second data. In this case, the plurality of third data may be data of a previous layer necessary to generate the second data.

In operation S130, the computing device may perform pruning. In some embodiments, the computing device may remove all the first plurality of weights included in the first output channel associated with the first data.

In some embodiments, the computing device may include a first layer, a second layer and third layers in which convolution operations are sequentially performed. The first layer may include the up-scaled weights and the plurality of third data to be convolved with the up-scaled weights. The second layer may include the second data and the plurality of down-scaled weights included in the first output channel. The third layer may include the first data on which the pruning will be performed.

In some embodiments, the third layer of the computing device may further include fourth data. The fourth data may be data included in the same layer (i.e., the third layer) as the first data on which the pruning will be performed. The second layer being a previous layer of the third layer may further include a second output channel associated with the fourth data. The computing device may calculate the fourth data based on the second data, which are calculated based on the up-scaled weights, and a weight included in the second output channel.

In some embodiments, the third layer of the computing device may further include fifth data. The fifth data may be data included in the same layer (i.e., the third layer) as the first data, on which the pruning will be performed, and the fourth data compensating for an influence of the pruning. The second layer being a previous layer of the third layer may further include a third output channel associated with the fifth data. The computing device may calculate the fifth data based on the second data, which are calculated based on the up-scaled weights, and a weight included in the third output channel.

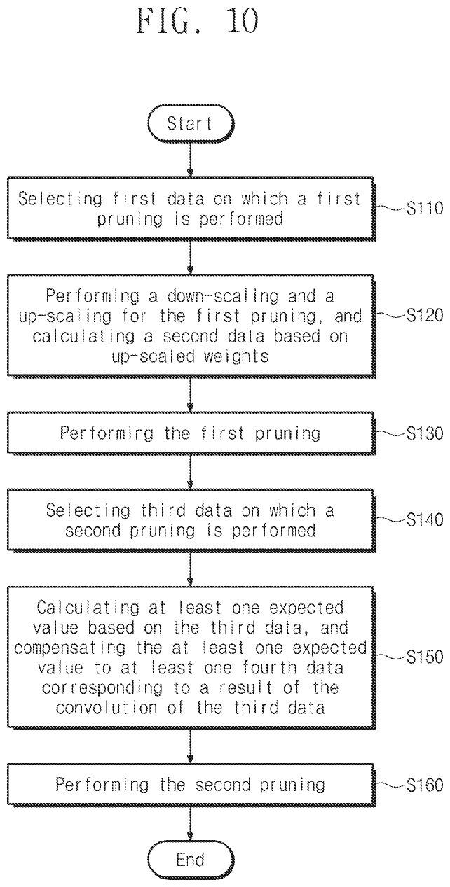

FIG. 10 is a flowchart illustrating a method of FIG. 9 in more detail, according to some embodiments of the present disclosure. An operation method of a computing device according to some embodiments is illustrated in FIG. 10. The computing device may communicate with a memory device. First pruning of FIG. 10 may correspond to the pruning of FIG. 9. Operation S110 is similar to operation S110 of FIG. 9, operation S120 is similar to operation S120, operation S121, and operation S122 of FIG. 9, and operation S130 is similar to operation S130 of FIG. 9. Thus, additional description will be omitted to avoid redundancy.

In operation S140, the computing device may select third data on which the second pruning will be performed.

In operation S150, the computing device may calculate at least one expected value based on the third data and may apply (or add) the at least one expected value to at least one fourth data corresponding to a convolution result of the third data for the purpose of compensation (e.g., to compensate for the loss of accuracy resulting from pruning). In some embodiments, the computing device may add a corresponding expected value of the at least one expected value to each of the at least one fourth data corresponding to the convolution result of the third data. For example, as illustrated in the FIG. 6B, the computing device may add a corresponding expected value (DT2-3*WT2-31) to a corresponding data DT3-1, add a corresponding expected value (DT2-3*WT2-32) to a corresponding data DT3-2, and add a corresponding expected value (DT2-3*WT2-33) to a corresponding data DT3-3.

In operation S160, the computing device may perform the second pruning. In some embodiments, the computing device may remove all the weights included in an output channel associated with the third data on which the second pruning will be performed.

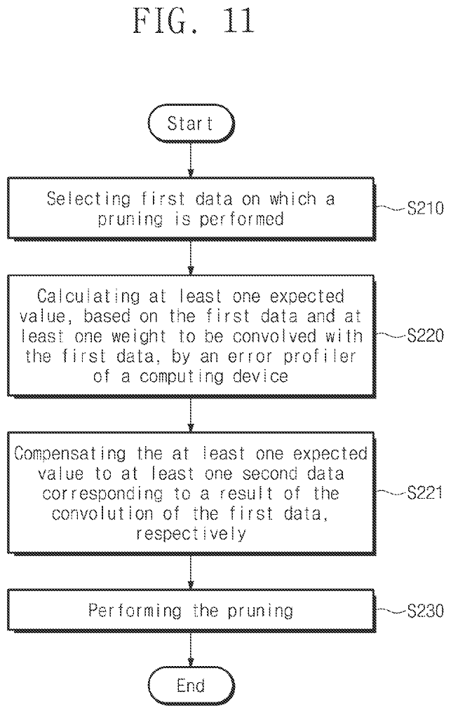

FIG. 11 is a flowchart illustrating an operation method of a computing device according to an embodiment of the present disclosure. An operation method of a computing device is illustrated in FIG. 11. The computing device may communicate with a memory device. In operation S210, the computing device may select first data on which the pruning is to be performed.

In operation S220, the error profiler of the computing device may calculate at least one expected value based on the first data and at least one weight to be convolved with the first data.

In operation S221, for the purpose of compensation (e.g., to compensate for the loss of accuracy resulting from pruning), the computing device may apply the at least one expected value calculated in operation S220 to at least one second data corresponding to a convolution result of the first data. In some embodiments, the computing device may add a corresponding expected value of the at least one expected value to a bias value of each of the at least one second data.

In operation S230, the computing device may perform pruning. In some embodiments, the computing device may remove all the weights included in the first output channel associated with the first data.

In some embodiments, the computing device may include a first layer, a second layer and a third layer in which convolution operations are sequentially performed. The first layer may include a first plurality of weights included in a first output channel associated with the first data to be pruned and a plurality of third data to be convolved with the first plurality of weights included in the first output channel. The second layer may include the first data to be pruned and at least one weight to be convolved with the first data. The third layer may include at least one second data corresponding to a convolution result of the first data.

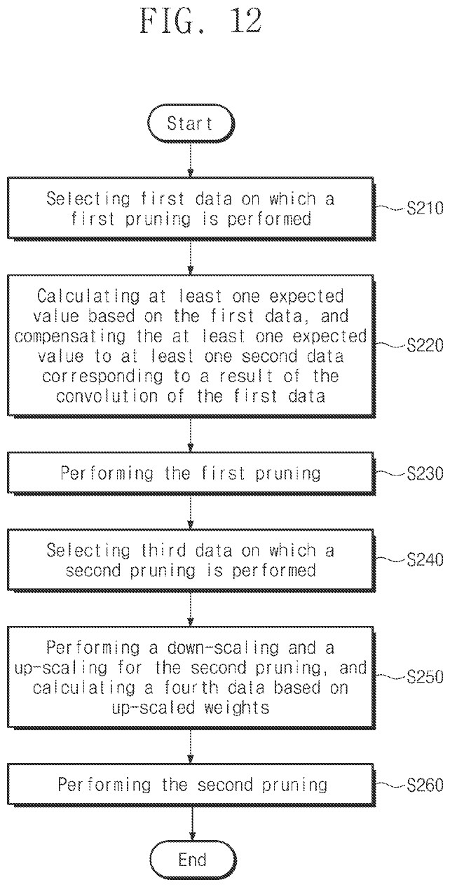

FIG. 12 is a flowchart illustrating a method of FIG. 11 in more detail, according to some embodiments of the present disclosure. An operation method of a computing device according to some embodiments is illustrated in FIG. 12. The computing device may communicate with a memory device. First pruning of FIG. 12 may correspond to the pruning of FIG. 11. Operation S210 is similar to operation S210 of FIG. 11. Operation S220 is similar to operation S220 and operation S221 of FIG. 11. Operation S230 is similar to operation S230 of FIG. 11. Thus, additional description will be omitted to avoid redundancy.

In operation S240, the computing device may select third data on which the second pruning will be performed.

In operation S250, the computing device may perform down-scaling and up-scaling for the second pruning and may calculate fourth data based on up-scaled weights.

In some embodiments, the computing device may down-scale a first plurality of weights included in an output channel associated with the third data on which the second pruning will be performed. The computing device may up-scale a second plurality of weights that are used to generate fourth data to be multiplied by a weight having a major value from among the plurality of weights included in the output channel associated with the third data. In some embodiments, the computing device may perform up-scaling and down-scaling based on a plurality of scaling values determined in advance.

In operation S260, the computing device performs the second pruning. In some embodiments, the computing device may remove all the weights included in the output channel associated with the third data.

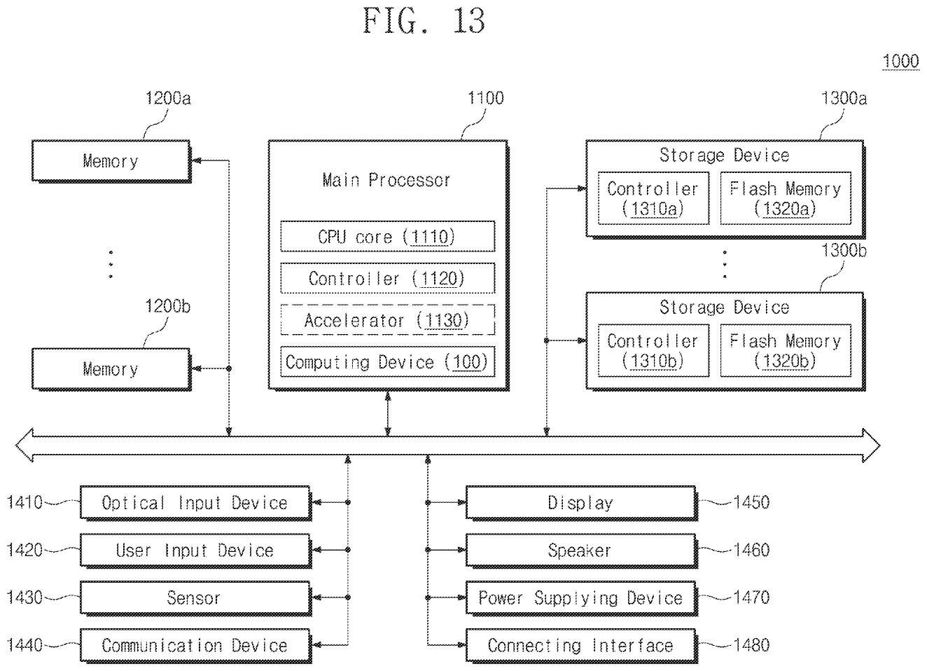

FIG. 13 is a block diagram illustrating an electronic system including a computing device, according to some embodiments of the present disclosure. An electronic system 1000 of FIG. 13 may be a mobile system such as a mobile phone, a smartphone, a tablet personal computer (PC), a wearable device, a healthcare device, or an Internet of Things (IoT) device. However, the electronic system 1000 is not limited to the mobile system. For example, the electronic system 1000 may be a personal computer, a laptop, a server, a media player, or an automotive device such as a navigation system.

Referring to FIG. 13, the electronic system 1000 may include a main processor 1100, memories 1200a and 1200b, and storage devices 1300a and 1300b. The electronic system 1000 may further include one or more of an optical input device 1410, a user input device 1420, a sensor 1430, a communication device 1440, a display 1450, a speaker 1460, a power supplying device 1470, and a connecting interface 1480.

The main processor 1100 may control overall operations of the electronic system 1000, in more detail, may control operations of the remaining components of the electronic system 1000 implementing the electronic system 1000. The main processor 1100 may be implemented with a general-purpose processor, a dedicated processor, an application processor, or the like.

The main processor 1100 may include one or more CPU cores 1110 and may further include a controller 1120 for controlling the memories 1200a and 1200b and/or the storage devices 1300a and 1300b. In some embodiments, the main processor 1100 may further include an accelerator 1130 being a dedicated circuit for high-speed data computation such as artificial intelligence (AI) data computation. The accelerator 1130 may include a graphics processing unit (GPU), a neural processing unit (NPU), and/or a data processing unit (DPU) and may be implemented with a separate chip physically independent of any other component of the main processor 1100.

The main processor 1100 may include the computing device 100. The computing device 100 may correspond to a computing device described with reference to FIG. 1 through FIG. 12. The computing device 100 may be provided as a separate component in the main processor 1100 or may be included in the one or more CPU cores 1110, the controller 1120, or the accelerator 1130 of the main processor 1100.

The memories 1200a and 1200b may be used as a main memory device of the electronic system 1000 and may include a volatile memory such as a static random access memory (SRAM) and/or a dynamic random access memory (DRAM). However, the memories 1200a and 1200b may include a nonvolatile memory such as a flash memory, a phase change RAM (PRAM), and/or a resistive RAM (RRAM). The memories 1200a and 1200b may be implemented within the same package as the main processor 1100.

The storage devices 1300a and 1300b may function as a nonvolatile memory device storing data regardless of whether a power is supplied and may have a relatively large storage capacity compared to the memories 1200a and 1200b. The storage device 1300a may include a storage controller 1310a and a non-volatile memory 1320a (NVM) storing data under control of the storage controller 1310a, and the storage device 1300b may include a storage controller 1310b and a non-volatile memory 1320b (NVM) storing data under control of the storage controller 1310b. Each of the non-volatile memory 1320a and the non-volatile memory 1320b may include a flash memory of a two-dimensional (2D) structure or a V-NAND flash memory of a three-dimensional structure or may include a different kind of nonvolatile memory such as a PRAM or a RRAM.

The storage devices 1300a and 1300b may be included in the electronic system 1000 in a state of being physically separated from the main processor 1100 or may be implemented within the same package as the main processor 1100. Alternatively, the storage devices 1300a and 1300b may be implemented in the form of a solid state drive (SSD) or a memory card. In this case, the storage devices 1300a and 1300b may be removably connected with any other components of the electronic system 1000 through an interface to be described later, such as the connecting interface 1480. The storage devices 1300a and 1300b may include a device to which the standard such as universal flash storage (UFS), embedded multi-media card (eMMC), or non-volatile memory express (NVMe) is applied, not limited thereto.

In some embodiments, at least one of the memories 1200a and 1200b and the storage devices 1300a and 1300b may provide data and a weight for a convolution operation and pruning of the computing device 100. For example, at least one of the memories 1200a and 1200b and the storage devices 1300a and 1300b may correspond to the memory device 200 of FIG. 1.

The optical input device 1410 may photograph (or capture) a still image or a moving image and may include a camera, a camcorder, and/or a webcam.

The user input device 1420 may receive various types of data input by a user of the electronic system 1000 and may include a touch pad, a keypad, a keyboard, a mouse, and/or a microphone.

The sensor 1430 may detect various types of physical quantities capable of being obtained from the outside of the electronic system 1000 and may convert the detected physical quantities to electrical signals. The sensor 1430 may include a temperature sensor, a pressure sensor, an illumination sensor, a position sensor, an acceleration sensor, a biosensor, and/or a gyroscope sensor.

The communication device 1440 may communicate with external devices of the electronic system 1000 in compliance with various communication protocols. The communication device 1440 may be implemented to include an antenna, a transceiver, and/or a MODEM.

The display 1450 and the speaker 1460 may function as an output device that outputs visual information and auditory information to the user of the electronic system 1000.

The power supplying device 1470 may appropriately convert a power supplied from a battery (not illustrated) embedded in the electronic system 1000 and/or an external power source so as to be supplied to each component of the electronic system 1000.

The connecting interface 1480 may provide a connection between the electronic system 1000 and an external device. The connecting interface 1480 may be implemented with various interfaces such as an ATA (Advanced Technology Attachment) interface, an SATA (Serial ATA) interface, an e-SATA (external SATA) interface, an SCSI (Small Computer Small Interface) interface, an SAS (Serial Attached SCSI) interface, a PCI (Peripheral Component Interconnection) interface, a PCIe (PCI express) interface, an NVMe (NVM express) interface, an IEEE 1394 interface, an USB (Universal Serial Bus) interface, an SD (Secure Digital) card interface, an MMC (Multi-Media Card) interface, an eMMC (embedded Multi-Media Card) interface, an UFS (Universal Flash Storage) interface, an eUFS (embedded Universal Flash Storage) interface, and a CF (Compact Flash) card interface.

According to some embodiments of the present disclosure, an operation method of a computing device that performs processes of the present disclosure may be implemented with a computer code in a non-transitory computer-readable recording medium. For example, a program, software, instructions, etc. for a series of operations included in the method for performing the pruning of the present disclosure may be stored in the non-transitory computer-readable recording medium. The program, software, or instructions, when executed by the processor, may cause the processor to perform a series of operations for the pruning.

According to an embodiment of the present disclosure, a computing device capable of compensating for the reduction of accuracy caused by pruning and an operation method thereof are provided.

Also, according to some embodiments of the present disclosure, a computing device that increases an operating speed by performing structured pruning, minimizes the reduction of accuracy due to the pruning by adjusting a scale of weights used to generate data to be pruned, and compensates for an error due to the pruning by applying an expected value of a convolution operation, which is based on the data to be pruned, to data of a next layer for the purpose of compensation (e.g., to compensate for the loss of accuracy resulting from pruning), and an operation method thereof are provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An operation method of a computing device, the method comprising:
selecting first data on which a first pruning is to be performed;
down-scaling a first plurality of weights included in a first output channel associated with the first data;
up-scaling a second plurality of weights used to generate second data to be multiplied by a weight having a major value from among the down-scaled first plurality of weights included in the first output channel;
calculating the second data based on the up-scaled second plurality of weights; and
performing the first pruning.

2. The operation method of claim 1, wherein the performing of the first pruning includes:
removing all the down-scaled first plurality of weights included in the first output channel associated with the first data.

3. The operation method of claim 1, wherein the down-scaling of the first plurality of weights included in the first output channel associated with the first data includes:
down-scaling the first plurality of weights included in the first output channel with a plurality of predetermined scaling values, respectively, and
wherein the up-scaling of the second plurality of weights used to generate the second data to be multiplied by the weight having the major value from among the down-scaled first plurality of weights included in the first output channel includes:
up-scaling the second plurality of weights used to generate the second data with the plurality of predetermined scaling values, respectively.

4. The operation method of claim 1, wherein the calculating of the second data based on the up-scaled second plurality of weights includes:
performing a convolution operation on the up-scaled second plurality of weights and a plurality of third data to obtain the second data.

5. The operation method of claim 1, wherein the computing device includes a first layer, a second layer and a third layer in which convolution operations are sequentially performed,
wherein the first layer includes the up-scaled second plurality of weights and a plurality of third data to be convolved with the up-scaled second plurality of weights,
wherein the second layer includes the second data and the down-scaled first plurality of weights included in the first output channel, and
wherein the third layer includes the first data.

6. The operation method of claim 5, wherein the third layer further includes fourth data,
wherein the second layer further includes a second output channel associated with the fourth data, and
wherein the operation method further comprises:
calculating the fourth data based on the second data and a weight included in the second output channel.

7. The operation method of claim 6, wherein the third layer further includes fifth data,
wherein the second layer further includes a third output channel associated with the fifth data, and
wherein the operation method further comprises:
calculating the fifth data based on the second data and a weight included in the third output channel.

8. The operation method of claim 1, further comprising:
selecting third data on which a second pruning is to be performed;
calculating, by an error profiler of the computing device, at least one expected value based on the third data and at least one weight to be convolved with the third data;
applying the at least one expected value to at least one fourth data corresponding to a convolution result of the third data for purpose of compensation; and
performing the second pruning.

9. The operation method of claim 8, wherein the performing of the second pruning includes:
removing all weights included in a second output channel associated with the third data.

10. The operation method of claim 8, wherein the applying of the at least one expected value to the at least one fourth data corresponding to the convolution result of the third data for purpose of compensation includes:
adding a corresponding expected value of the at least one expected value to a bias value of each of the at least one fourth data.

11. An operation method of a computing device, the method comprising:
selecting first data on which a first pruning is to be performed;
calculating, by an error profiler of the computing device, at least one expected value based on the first data and at least one weight to be convolved with the first data;
applying the at least one expected value to at least one second data corresponding to a convolution result of the first data for purpose of compensation; and
performing the first pruning.

12. The method of claim 11, wherein the performing of the first pruning includes:
removing all weights included in a first output channel associated with the first data.

13. The method of claim 11, wherein the applying of the at least one expected value to the at least one second data corresponding to the convolution result of the first data for purpose of compensation includes:
adding a corresponding expected value of the at least one expected value to a bias value of each of the at least one second data.

14. The method of claim 11, wherein the computing device includes a first layer, a second layer and a third layer in which convolution operations are sequentially performed,
wherein the first layer includes a first plurality of weights included in a first output channel associated with the first data and a plurality of third data to be convolved with the first plurality of weights included in the first output channel,
wherein the second layer includes the first data and the at least one weight to be convolved with the first data, and
wherein the third layer includes the at least one second data.

15. The method of claim 11, further comprising:
selecting third data on which a second pruning is to be performed;
down-scaling a second plurality of weights included in an output channel associated with the third data;
up-scaling a third plurality of weights used to generate fourth data to be multiplied by a weight having a major value from among the down-scaled second plurality of weights included in the output channel;
calculating the fourth data based on the up-scaled third plurality of weights; and
performing the second pruning.

16. The method of claim 15, wherein the performing of the second pruning includes:
removing all the weights included in the down-scaled second plurality of weights included in the output channel associated with the third data.

17. The method of claim 15, wherein the down-scaling of the second plurality of weights included in the output channel associated with the third data includes:
down-scaling the second plurality of weights included in the output channel with a plurality of predetermined scaling values, respectively, and
wherein the up-scaling of the third plurality of weights used to generate the fourth data to be multiplied by the weight having the major value from among the down-scaled second plurality of weights included in the output channel includes:
up-scaling the third plurality of weights used to generate the fourth data with the plurality of predetermined scaling values, respectively.

18. A computing device, comprising:
a channel pruner configured to select first data on which a first pruning is to be performed and second data on which second pruning is to be performed;
a scaling calculator configured to down-scale a first plurality of weights included in a first output channel associated with the first data, and to up-scale a second plurality of weights used to generate third data to be multiplied by a weight having a major value from among the down-scaled first plurality of weights included in the first output channel;
an error compensator configured to calculate at least one expected value based on the second data and at least one weight to be convolved with the second data, and to apply the at least one expected value to at least one fourth data corresponding to a convolution result of the second data for purpose of compensation; and
a convolution calculator configured to calculate the third data based on the up-scaled second plurality of weights.

19. The computing device of claim 18, further comprising:
a buffer memory configured to store a first layer, a second layer and a third layer; and
a memory interface configured to communicate with an external memory device and the buffer memory,
wherein the first layer includes the up-scaled second plurality of weights and a plurality of fifth data to be convolved with the up-scaled second plurality of weights,
wherein the second layer includes the third data, the down-scaled first plurality of weights included in the first output channel, the second data, and the at least one weight to be convolved with the second data, and
wherein the third layer includes the first data and the at least one fourth data.

20. The computing device of claim 18, wherein the channel pruner is further configured to:
perform the first pruning by removing all the weights included in the first output channel associated with the first data; and
perform the second pruning by removing all weights included in a second output channel associated with the second data.
